(19) United States
(12) Patent Application Publication
(10) Pub. No.: US 2024/0064712 A1
(43) Pub. Date: Feb. 22, 2024

(54) IOT SATELLITE COMMUNICATION OPTIMIZATION

(71) Applicant: Gorilla Link LTD, Tel Aviv (IL)

(72) Inventors: Nadav NACHSHON, Tel Aviv (IL); Ron NACHSHON, Hod HaSharon (IL)

(73) Assignee: Gorilla Link LTD, Tel Aviv (IL)

(21) Appl. No.: 18/234,433

(22) Filed: Aug. 16, 2023

Related U.S. Application Data
(60) Provisional application No. 63/398,908, filed on Aug. 18, 2022.

(51) Int. Cl. H04W 72/0446; H04W 28/24

(52) U.S. Cl. CPC H04W 72/0446; H04W 28/24

(57) ABSTRACT

An Internet of Things (IoT) device includes processing circuitry. The IoT device maintains a list of time slots which are available for communicating over at least one satellite communication network. The list includes respective parameter information for the available time slots. The IoT device selects at least one of the time slots for transmission of a data item based on a joint analysis of properties of the data item type and the respective parameter information. The data item is uploaded during selected time slot(s) over a satellite communication network associated with the time slot. A similar analysis is performed to select a time slot for downloading a data item from the satellite communication network.

### RELATED APPLICATION(S)

This application claims the benefit of priority under 35 USC § 119(e) of U.S. Provisional Patent Application No. 63/398,908 filed on Aug. 18, 2022, the contents of which are all incorporated by reference as if fully set forth herein in their entirety.

### FIELD AND BACKGROUND OF THE INVENTION

Some embodiments described in the present disclosure relate to Internet of Things devices and systems and, more specifically, but not exclusively, to satellite communications by Internet of Things devices.

The Internet of Things (IoT) is a rapidly developing technology with a wide range of applications, such as smart homes, healthcare, monitoring and controlling manufacturing facilities, collecting agricultural data and much more. IoT devices have integral processing capabilities and communicate over a network in order to implement the IoT application. IoT devices often collect local data using sensors and upload the collected data over the communication network. They may also manage other devices or processes in their vicinity based on information received over the network.

In many areas, the IoT device has relatively simple access to a network (e.g. cellular network or the Internet) as well as readily available power. However problems arise when IoT devices are employed in remote areas in which cellular or wired network access is unavailable. In such cases communication may be possible only over a satellite network. Managing satellite communications by a network that includes a large number of IoT devices (possibly thousands or more) is a complex task, which must take into account the availability of satellite networks, satellite communication vendor protocols, reliability of the satellite communication connection and many other factors. This management is typically outside the purview of the IoT application developers and requires dedicated satellite communication specialists to integrate satellite communication capabilities into the IoT application.

Additionally, in remote areas the IoT device often relies completely on battery power. Very careful management of power usage for processing, communication and other operations is necessary in order to extend the lifetime of the battery as much as possible.

### SUMMARY OF THE INVENTION

It is an object of the present disclosure to describe a system and a method for optimizing satellite communications for IoT systems and devices.

The foregoing and other objects are achieved by the features of the independent claims. Further implementation forms are apparent from the dependent claims, the description and the figures.

According to a first aspect of some embodiments of the present invention there is provided Internet of Things (IoT) device which includes processing circuitry. The processing circuitry:
maintains a list of time slots available to the device for communicating over at least one satellite communication network, the list comprising respective parameter information for the available time slots;
selects at least one of the time slots for transmission of a data item based on a joint analysis of properties of a type of the data item and the respective parameter information; and
uploads the data item during the at least one selected time slots over a satellite communication network associated with the time slot.

According to a second aspect of some embodiments of the present invention there is provided a method of self-management of satellite communications by an Internet of Things (IoT) device. The method includes:
maintaining a list of time slots available to the device for communicating over at least one satellite communication network, the list comprising respective parameter information for the available time slots;
selecting at least one of the time slots for transmission of a data item based on a joint analysis of properties of a type of the data item and the respective parameter information; and
uploading the data item during the at least one selected time slots over a satellite communication network associated with the time slot.

According to some embodiments of the invention, the respective parameter information includes an estimated probability of success for communication during the time slot.

According to some embodiments of the invention, the device is capable of communicating over multiple satellite communication networks and the parameter information includes a respective satellite network associated with the time slot.

According to some embodiments of the invention, the processing circuitry receives data over a satellite communication network during a time slot selected based on a joint analysis of a type of the data to be received and the respective parameter information.

According to some embodiments of the invention, the time slots are time periods during which respective estimated probabilities for successful communication during the time slot exceed a threshold value.

According to some embodiments of the invention, for at least one of the time slots the parameter information includes an indicator indicating at least one of whether uplink communication is permitted during said time slot and whether downlink communication is permitted during said time slot.

According to some embodiments of the invention, the properties include at least one of: power requirements, latency, quality of service (QoS) and encoding.

According to some embodiments of the invention, the parameter information includes a financial cost for use of the time slot.

According to some embodiments of the invention, maintaining the list of time slots available to the device includes querying a server for the list of available time slots for an upcoming time period.

According to some embodiments of the invention, maintaining the list of time slots available to the device includes receiving, from a server over a communication network, a message comprising the list of available time slots.

According to some embodiments of the invention, the selecting at least one of said time slots for transmission includes querying a server to return at least one time slot selected from the list for transmission of the data item.

According to some embodiments of the invention, the IoT device functions as a hub collecting data from a network of sensors. According to some further embodiments of the invention, the IoT device collects data from the network of sensors and forms the collected data into at least one data item for transmission over a satellite communication network.

According to a third aspect of some embodiments of the present invention there is provided a server which includes processing circuitry. The processing circuitry is configured to:
map satellite locations for multiple satellite communication networks;
based on the mapping and respective physical locations of Internet of Things (IoT) devices, generate respective lists of time slots for the IoT devices, each of the respective lists including a multiple time slots available for communication by the IoT device over the satellite communication networks and respective estimated probabilities of success for the satellite communication during the available time slots; and
provide the respective lists to the IoT devices.

According to some embodiments of the invention, the server is further configured to provide the respective list in response to a query from the IoT device.

According to some embodiments of the invention, the server is further configured to push the respective list to the IoT device over a satellite communication network.

According to some embodiments of the invention, the server is further configured to return a selected time slot for transmission of a data item in response to a request from the IoT device, the time slot being selected from the respective list of available time slots based on a type of the data item and the respective estimated probabilities of success.

According to a fourth aspect of some embodiments of the present invention there is provided a method of facilitating satellite communications for an Internet of Things (IoT) device. The method includes:
mapping satellite locations for multiple satellite communication networks;
based on the mapping and respective physical locations of multiple IoT devices, generating respective lists of time slots for the IoT devices, each of the respective lists including multiple time slots available for communication by the IoT device over the satellite communication networks and respective estimated probabilities of success for the satellite communication during the available of time slots; and
providing the respective lists to the IoT devices.

According to some embodiments of the invention, the probabilities are estimated based on at least one of: orbital information for satellites of the satellite communication networks, atmospheric conditions at the location of the IoT device, satellite constellation health, satellite health and feedback from a ground station.

According to some embodiments of the invention, the available time slots are time periods during which respective estimated probabilities for successful communication during the time slot exceed a threshold value.

According to some embodiments of the invention, at least one of the lists further includes respective parameter information for the available time slots.

According to some embodiments of the invention, the parameter information includes respective satellite communication networks associated with the available time slots.

According to some embodiments of the invention, the parameter information includes an indicator indicating at least one of whether uplink communication is permitted during the time slot and whether downlink communication is permitted during the time slot.

According to some embodiments of the invention, the parameter information comprises a financial cost for use of the time slot.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a simplified network diagram of an exemplary IoT system using satellite communications, according to embodiments described in the present disclosure;

FIG. 2 is a simplified schematic diagram of an IoT device, according to some exemplary embodiments described in the present disclosure;

FIG. 3 is a simplified block diagram of an IoT device, according to some exemplary embodiments described in the present disclosure;

FIG. 4 is a simplified flowchart of a method of self-management of satellite communications by an Internet of Things (IoT) device, according to embodiments described in the present disclosure;

FIG. 5 is a simplified illustration of a time slot list formatted for storage on the IoT device in table format;

FIG. 6 is a simplified block diagram of an exemplary facilitation server, according to embodiments described in the present disclosure;

FIG. 7 is a simplified flowchart of a method of facilitating satellite communications for an Internet of Things (IoT) device according to embodiments described by the present disclosure;

FIGS. 8A and 8B are simplified diagrams illustrating optional flows of operations for identifying available time slots for IoT devices, according to respective embodiments described in the present disclosure; and

FIG. 9 shows an exemplary page for inputting data type properties as displayed on a GUI, according to embodiments described in the present disclosure.

### DESCRIPTION OF SPECIFIC EMBODIMENTS OF THE INVENTION

Some embodiments described in the present disclosure relate to Internet of Things devices and systems and, more specifically, but not exclusively, to satellite communications by Internet of Things devices.

IoT applications are prevalent in many technological fields. One challenge of developing an IoT application is to optimize usage of the device resources, such as power consumption and processing capacity. This optimization is particularly critical when these resources are extremely limited.

A major consumer of IoT device resources is communication. Even if the amount of data being sent by the IoT device is small, failure to attain successful communication may cause the device to resend the same data repeatedly until the communication is successful. IoT devices have a wide range of communication needs, depending on the type of device and the IoT application requirements. For example, some devices may need to transmit small amounts of data (e.g. tens of bytes) several time a day. Other devices collect data over larger periods of time and transmit less frequently. A single IoT device may need to transmit different types of data, some of which is transmitted more frequently or more urgently than other data. It is important that power usage be minimized while still obtaining a desired level of successful communication for the data transmitted and/or received by the device.

Communication requirements for IoT applications often involve a tradeoff between different parameters. Examples of such tradeoffs include:
1) Secured communication vs. payload size—Some high-level encryptions increase payload size, which in turn increases the required air-time. This may make it difficult to find time slots which can carry the increased pay load and/or increase the financial cost. Handshakes like the one used in TLS require fast downlink communication, again limiting the number of suitable time slots. Asymmetric encryptions like RSA or ECC require increasing payloads dramatically for both key exchange and encrypted data payloads. Embodiments of the invention select time slots which balance communication security requirements with payload size (while possibly minimizing financial cost).
2) Secured communication vs. power—Encryption is very power-hungry and takes time (e.g. longer wake duty cycles and shorter battery life). It also requires a large amount of calculations so large parts of the micro-controller unit (MCU) are up and running for certain operations. Embodiments of the invention support both encrypted and “in the clear” messages under the same protocol so that the data may be encrypted only when necessary. The same IoT device and data pipeline support both encrypted and unencrypted messages. In one example the IoT device sends a Quality of Service (QoS) parameter value to a remote gateway and the gateway adds only the encryption necessary to meet the desired QoS while taking into account the encryption level offered by the network.
3) Quality of service vs. power and air-time—Listening to acknowledgement messages forces the device to stay on longer and thus costs more in air time and power. For example, the MQ Telemetry Transport (MQTT) quality of service metric includes three levels:
   QOS_0—Message is unacknowledged.
   QOS_1—Message is acknowledged once.
   QOS_2—Message is acknowledged twice.
      It may be desirable to select a later time slot which does not exceed the QoS requirements, rather than transmitting the data items sooner with a higher QoS than necessary.
4) Latency vs. communication resource usage—In some embodiments an IoT device has more than one communication device. When low latency is desired, the IoT device may transmit over more than one network simultaneously. This enables transmitting a data item with low latency at the cost of increasing resource usage (power, increased financial cost, etc.).

The embodiments described herein provide a solution to the technical problem of optimizing IoT device satellite communications. Time slots are selected for transmission and/or reception of data items in order to obtain a desired probability of success for the communication and in accordance with properties specified for that type of data item. The time slots are selected from a time slot list which is calculated based on the physical location of the device, satellite orbital information and optionally other factors.

In some embodiments, when the IoT device is prepared to transmit a data item of a given type it jointly analyzes the properties of that type of data item (also denoted the data type properties) and information in the time slot list. In one example the analysis is a simple elimination process, which removes time slots which do not satisfy the required data type properties until a smaller list of suitable time slots is obtained. The data item is transmitted during one of the remaining time slots, which is selected to optimize a specified parameter (e.g. lowest latency or best QoS). A similar analysis may be performed for receiving data items over the satellite network.

Optionally, the time slot list is calculated off the device, thus reducing the computational load on the device. In some embodiments the time slot list is pre-stored on the device and optionally updated over the satellite communication network (also denoted the satellite network).

Alternately or additionally, orbital information is stored on the device and the device uses the orbital information during the time slot selection process.

The systems and/or methods described herein are necessarily rooted in and IoT system technology to overcome a problem arising in satellite communications by IoT devices. The time slot selection embodiments described in the present disclosure provide a simple technical solution to the technical problem of optimizing satellite communications by IoT devices with limited power and other resources, while still balancing different communication requirement and goals.

Embodiments described herein are not limited to a single satellite network or a single type of satellite network. The IoT device may switch between satellite communication networks simply by updating the time slot list, if it has a modem suitable for the new satellite network. Types of satellite networks which may be used for IoT device communication include but are not limited to:
a) Low Earth orbit (LEO);
b) Medium Earth orbit (MEO);
c) Geostationary orbit;
d) Low latency blimp-based networks;
e) Sun synchronous orbit;
f) Molniya orbit;
g) Tundra orbits; and
h) Earth observation solutions.

This flexibility frees the IoT application from dependence on a single satellite network or communications services vendor.

The benefits of the embodiments presented herein include:
1) Uplink and downlink satellite communication may be tailored to the type of data being transmitted and/or received.
2) Capable of handling multiple satellite networks and satellite communication protocols.
3) Does not require any satellite communications knowledge by the IoT application developer. The application developer operates at a high abstraction level.
4) Regulatory issues—Countries often regulate which satellite communication system(s) may be used in their territory. The present embodiments may ensure that the IoT device conforms to the local regulation without any involvement of the IoT device application layer.
5) Increased efficiency—When a single device has more than one communication module on board it may use a low-power and efficient module when sending low QoS messages and switch to a less efficient but more reliable solution when higher QoS is required (for example for Over-the-air software updates).

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that when the present disclosure describes one or more entities or at least one entity performing more than one action, any of the entities may perform any combination of actions of the more than one action, such that any of a group of actions consisting of the more than one action is performed by any of the one or more entities or all the entities of the one or more entities.

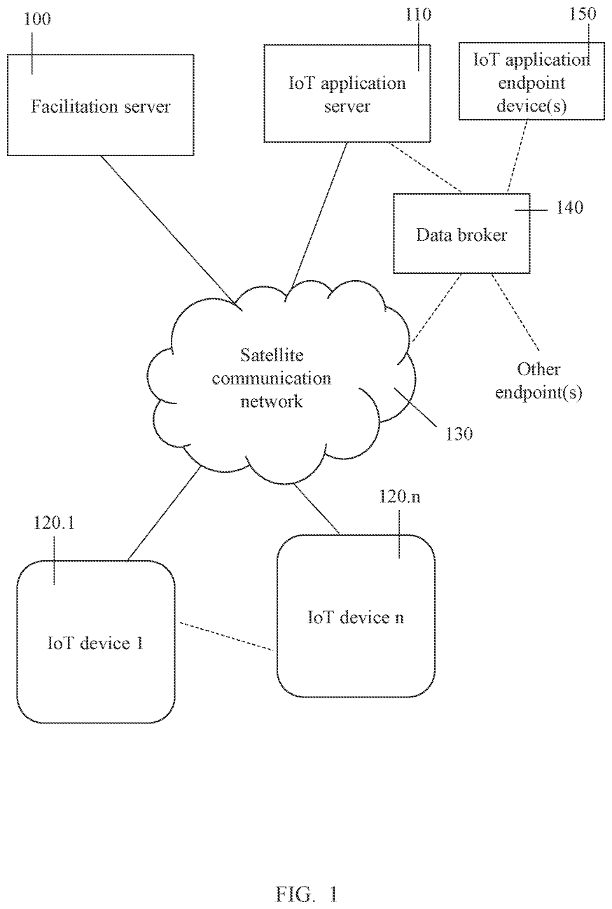

Reference is now made to FIG. 1 which is a simplified network diagram of an exemplary IoT system using satellite communications, according to embodiments described in the present disclosure. The network architecture includes a server 100 (denoted a facilitation server) that communicates with IoT devices 120.1-120.n over satellite communication network 130, in order to enable the IoT devices to optimize communication with IoT application server 110 (and optionally other network elements or IoT devices). Exemplary embodiments of satellite communication optimization by an IoT device are described in more detail below.

For clarity satellite communication network 130 is illustrated as a single network. It is to be understood, that satellite communication network 130 may include multiple satellite communication networks operating with the same and/or different protocols. This enables different devices to communicate over different satellite networks and/or a single device to communicate over multiple satellite networks.

Facilitation server 100 provides IoT devices 120.1-120.n with respective probabilities of success for satellite communication during specified time slots. The probabilities of success are calculated for the specific location of the IoT device, taking into account satellite locations relative to the specific device location. When an IoT device has a data item to transmit it selects one or more time slots for transmission of the data item based on the respective probabilities of success for the time slot and other factors related to the data item type. Time slot selection for a particular data item may optimize one or more criteria, as described in more detail below.

As used herein the terms “IoT device” and “device” mean a physical object with processing capabilities and the ability to transfer data over a communication network.

As used herein the terms “IoT device application” and “device application” mean a computer application which resides within the IoT device which manages IoT device operation, for example time slot selection.

As used herein the term “IoT application” means a computer application which interacts with multiple IoT devices in order to remotely monitor and/or control a system or environment.

As used herein the terms “time slot” and “available time slot” mean a time period which the IoT may select for uploading and/or downloading data items over the satellite communication network.

As used herein the term “probability of success” means the probability of a data frame transmitted over the satellite communication network from one terrestrial end to be received by the other terrestrial end. During uplink communication, the probability of success is the probability that a data frame transmitted by an IoT device over the satellite network will be received by the IoT application endpoint. During downlink communication, the probability of success is the probability that a data frame transmitted by an IoT application endpoint over the satellite network will be received by an IoT device or a group of IoT devices.

As used herein the term “satellite communication network” means a network in which data is routed over at least one satellite link. Satellite networks may further include a satellite network core that manages network traffic and performs operational functions such as billing and subscriptions.

As used herein the term “data item” means any data being uploaded and/or downloaded by the device over the satellite network as a single unit for the purposes of selecting a time slot or time slots. The term “data item” in itself does not limit the type of data, the size of the data item, the data item format or how it was formed into a single unit by the device. For example the data item may include data generated by the device and/or collected by the device from other devices and/or received by the device over the satellite network. It is also non-limiting as to the destination of uploaded data and/or the source of downloaded data.

As used herein the terms “type of the data item” and “data item type” denote a class of data items having the same properties.

Types of IoT devices include but are not limited to:
1) Infrastructure sensors;
2) Industrial sensors;
3) Wearable biometric sensors and remotely-controllable medical devices;
4) Environmental sensors;
5) Communication hub for other IoT devices;
6) Actuators (e.g. electrical relays, electric valves, switches, mechanical controls, etc.);
7) Asset tracking devices; and
8) Supply chain management and monitoring devices.

For clarity, facilitation server 100 is shown as a standalone computing system. Other embodiments will be readily apparent to the skilled person (for example as a distributed system comprising multiple physical and/or virtual machines, cloud storage and so forth).

In a first embodiment facilitation server 100 communicates with IoT devices 120.1-120.n and these devices perform time slot selection based on the probabilities of successful communication related to each time slot as provided by facilitation server 100 and on the relevant data item properties. In a second embodiment there is no downlink communication from facilitation server 100 to one or more of IoT devices 120.1-120.n. Devices with no downlink communication with facilitation server 100 perform time slot selection based on information pre-stored on the device. In a third embodiment there is no facilitation server and all of IoT devices 120.1-120.n perform time slot selection based on information pre-stored on the devices.

Optionally, at least one of IoT devices 120.1-120.n are connected to a sensing device and/or actuator.

IoT application runs on a server, device or system which processes the data items received from IoT devices 120.1-120.n in order to implement the desired usage of this data. IoT application server 110 may send data such as commands and queries to the IoT sensors in order to control the operation of the IoT devices. Alternately or additionally, the IoT application runs on other types of endpoint devices, for example, a mobile device, a smartphone, a tablet computer, a desktop computer, a notebook computer, a wearable computer, a watch computer, a glasses computer, and/or a computer connected to external devices such as a mouse, keyboard and display.

Optionally the IoT application runs on the facilitation server. In alternate embodiments the IoT application runs on a separate server and/or endpoint device.

In one example, the IoT application monitors and controls manufacturing equipment. The IoT devices may be sensors, processors and actuators. IoT application server 110 receives sensor data from the IoT devices over satellite communication network 130, processes the sensor information and sends commands to the IoT devices in order to control the manufacturing process.

In a second example, the IoT application is a medical application for monitoring patient health in remote locations. The IoT devices may be sensors (such as a blood pressure or activity monitor), medical implants and so forth. The IoT application analyzes data received from medical IoT devices and alerts the patient to seek help when it detects a problematic medical condition.

In a third example the IoT application is a safety application. The IoT devices are sensors (such as temperature and smoke detectors). The IoT application monitors the data received by IoT application server 110 from the IoT devices and alerts the local fire department when a temperature rise and smoke are detected by IoT devices in a particular location.

In a fourth example the IoT application is an environmental monitoring application, for example monitoring air quality over a large geographical region. IoT devices collect humidity, temperature and other data and sends it to IoT application server 110 over satellite communication network 130. The IoT application server 110 analyzes the data to detect long term environmental trends throughout the geographical region.

Additional possible applications are asset tracking (e.g. vehicle fleet management, tracking containers and cargo globally) and infrastructure monitoring (e.g. roads, bridges, pipelines, etc.).

Optionally, satellite communications to and/or from IoT devices 120.1-120.n are routed to the correct destination by data broker 140. For example, data broker 140 may route some data items to IoT application server 110 and other data items to different destinations such as IoT application endpoint device 150. FIG. 1 shows a non-limiting embodiment in which data broker 140 is external to satellite communication network 130. Alternately or additionally, data brokering may be performed within satellite communication network 130 (e.g. on a satellite).

Using an external data broker adds simplicity to the maintenance of the IoT application, and adds important layer separation and abstraction so that the IoT application and IoT device application may be agnostic to the specific communication solution that is used.

Benefits of using an external data broker include but are not limited to:
1) When an IoT device includes more than one communication module (e.g. modem), the data broker may control the destinations of the different modules at once without needing to configure each module separately. Thus if an IoT device has several satellite modems and it is necessary to reroute the data item to a different destination, the destination of each satellite network does not need to be reconfigured separately. Instead the address is changed in the data broker and all the traffic through all modems is redirected to the correct destination.
2) When an IoT application includes more than one type of IoT device and/or network of IoT devices, the data broker may use a single generic configuration of the entire system while remaining agnostic to differences between the networks.
3) The data broker enables fast routing of the traffic (by a simple application programming interface or graphical user interface) when the satellite networks require IP whitelisting and change routes very slowly.

Optionally, data broker 140 performs protocol conversion to ensure that the data may be transferred over the correct satellite network.

Optionally, data broker 140 records the successes and failures of transmissions. The recorded information may be used to update the probabilities of success calculated for the respective time slots.

Optionally the data broker includes multiple service-like software components including but not limited to:
1. Uplink manager;
2. Unacknowledged uplink broker;
3. Unacknowledged downlink broker;
4. Uplink acknowledgment manager;
5. Downlink acknowledgment manager; and
6. Downlink broadcast broker.

Using a separate uplink acknowledgement manager and downlink acknowledgement manager enables using a different network for the ACK message, thus optimizing communication. For example frames may be sent from IoT device to the IoT application server using one network (e.g. the Globalstar network) while an accumulative ACK message is sent using a second satellite network (for example SWARM constellation and not Globalstar). Applicant has found that this flexibility provides a dramatic improvement in efficient usage of IoT device resources while obtaining the required QoS, power consumption, pricing and so forth.

Optionally, data broker 140 includes a message composer which grabs frames sent from the device based on the message they are a part of. Thus the IoT application may support very large messages even when the actual over-the-air frame size is very small by slicing the message at the device side and recomposing at the message composer. The message composer may be agnostic to the network so that it composes messages even if the frames they are made of came from different networks.

### I) IoT Device

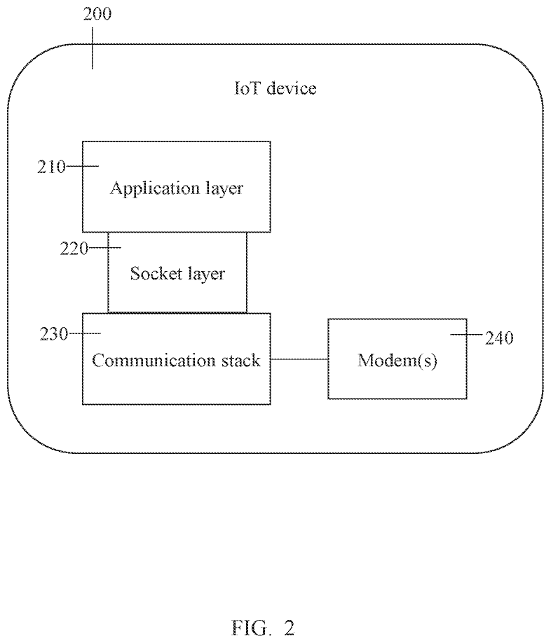

Reference is now made to FIG. 2 which is a simplified schematic diagram of an IoT device, according to some exemplary embodiments described in the present disclosure. While the description below is directed at uploading data items from the IoT device to the satellite network, it will be apparent to the skilled person that a similar process may performed for selecting of time slots for downloading data items.

IoT device 200 is based on a multi-layer architecture, which includes an application layer 210, socket layer 220 and communication stack 230.

Application layer 210 implements the logic and operation of the IoT device application. It creates the data items for uplink communication to the satellite network and processes data items received on downlink communication from the satellite network. When application layer 210 has a data item to transmit, it provides the data item to socket layer 220.

Socket layer 220 provides communication services for application layer 210. Socket layer 220 has access to information about the properties assigned to data items of that type by the IoT application. These data type properties may include but are not limited to:
i) Power requirements—In one example power requirements are optimized by setting a discrete power conservation level (PCL) for the data item type. A demand for high energy conservation (e.g. PCL=2) causes the device to use slots with high probability of success so that there will be fewer retries. This helps the communication stack resolve the tradeoff between latency and power conservation (e.g. should the data item be transmitted promptly and repeatedly even if success probability is low or the IoT device wait for time slot(s) that require fewer retransmissions and thus less power);
ii) Latency—The latency may be specified in discrete levels. In one example, data items with a low latency level are sent as soon as possible even when probability of success in the closest slot is low. They may also be sent repetitively with very long timeouts, so that a message may be sent several times before ACK message is received back. An additional option for IoT devices with more than one satellite network modem is that the communication stack retransmit on all available modems simultaneously. Data items with higher latency levels will not use all of these techniques. For example, sending the message may be delayed until a suitable slot with higher probability of success arrives and/or there may be a single transmission attempt instead of retransmissions. Generally, the lower the specified latency is the more power is used because of retransmission and more money is spent in order to achieve fast transmission;
iii) Quality of service (QoS)— usually specified as QOS_0, QOS_1 and QOS_2. In one example, when QoS_0 is required messages are unconfirmed, which requires very low power and has low cost. QOS_0 is typically suitable for messages that are not critical in nature. In contrast, when QoS_2 is required, the data broker itself confirms that the message was received, that error correction/detection was successful, and an appropriate ACK is sent back to the IoT device; and
iv) Encryption—The type of encryption used changes the data type length by orders of magnitude. Data item types which include non-sensitive information may be encrypted by less powerful standards and data item types which include more sensitive information may be encrypted by more powerful standards. The level of encryption is specified for the data item type and the “heavy lifting” of encrypting and decrypting the message is done automatically. This increases efficiency dramatically by sending non-sensitive data items as much shorter messages when possible.

Socket layer 220 analyzes the data type properties and selects one or more time slots for transmission of the data item. The time slot(s) fulfills the requirements given by the data type properties (e.g. the required QoS, encoding, etc.) while also obtaining a desired probability of transmission for the data item. Additional constraints (for example financial cost for use of a given slot) may also be taken into consideration by socket layer 220.

Communication stack 230 handles the satellite communication operations required for satellite communication via modem(s) 240. Communication stack 230 uploads the data item to the satellite network in the time slot(s) selected by socket layer 220. Communication stack 230 also provides time slot data (e.g. time slot parameters) to socket layer 220.

This multi-layer architecture provides a level of abstraction between the IoT application and the communication stack that enables the application designer to design the IoT application with minimal knowledge of satellite communications. The application designer simply specifies the properties of each data item type in the IoT application. The further steps of selecting time slots and communicating over the satellite network are performed by socket layer 220 and communication stack 230, without involvement of the device application running on IoT device 200.

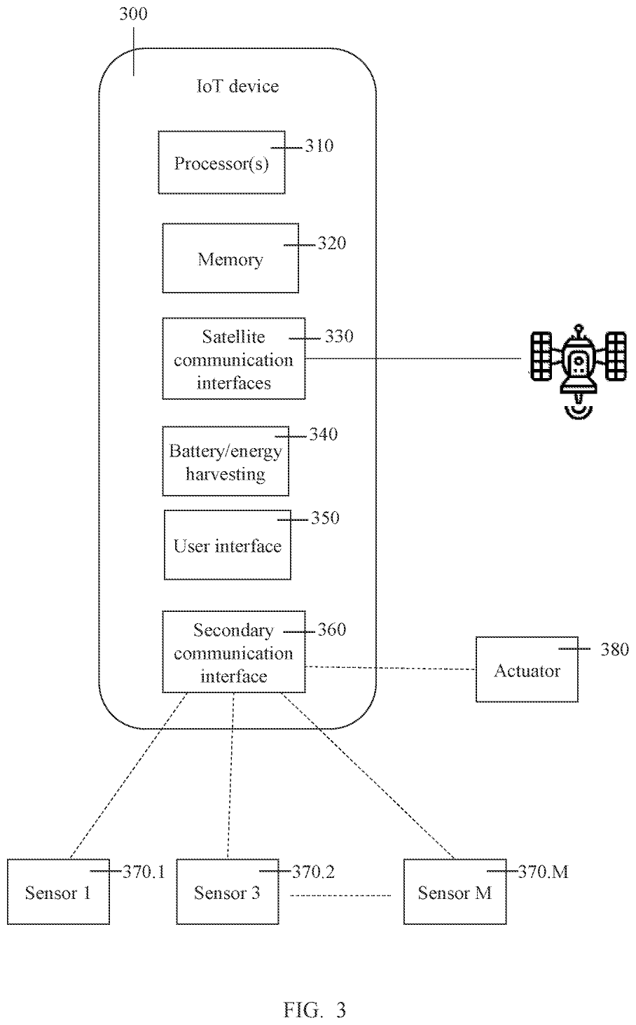

Reference is now made to FIG. 3 which is a simplified block diagram of an IoT device, according to some exemplary embodiments described in the present disclosure.

IoT device 300 includes at least one processor 310, memory 320 and satellite communication interface 330.

Processor(s) 310 perform the processing operations required for time slot selection as described herein.

Memory 320 stores information used for time slot selection. Optionally memory 320 stores additional information such as:
1) Program instructions for the device application;
2) Configuration information; and
3) Encryption-related data (such as encryption keys).

Satellite communication interface 330 uploads data items to the satellite communication network (e.g. collected sensor data) and downloads data from the satellite communication network (e.g. over-the-air updates or commands from an application server).

Optionally, processor(s) 310 is a microcontroller unit (MCU) embedded in the IoT device. Alternately or additionally, processor(s) 310 may include general purpose central processing unit(s) (CPU), field programmable gate array(s) (FPGA) and/or digital signal processor(s) (DSP) and/or application specific integrated circuits (ASIC).

Optionally, satellite communication interface 330 is capable of communicating over multiple satellite communication networks (e.g. has multiple satellite communication modems and/or a single modem with multiple network access). When a time slot is selected for transmission of a data item, the data item is transmitted over the satellite communication network associated with the selected time slot. Similarly, when a time slot is selected for reception of a data item, the data item is received over the satellite communication network associated with the selected time slot. Using more than one satellite communication networks has the benefit of increasing the number of available time slots, thereby enabling better optimization during the time slot selection process and overcoming regulatory issues.

In a first example, IoT device may use more than one network simultaneously in order to reduce latency. The data broker then accepts the first copy of the message and drops the rest or uses the redundant copies to assist with error correction. In a second example, the requirements for uplink and downlink communication are different. The IoT may communicate over one satellite communication network for the uplink and over a different satellite communication network for the downlink.

Optionally, IoT device includes a battery and/or energy harvesting device (e.g. solar panel). This enables the device to operate in locations where there is no other available power source.

Optionally, IoT device 300 includes a user interface (UI). For example, the UI may be used when hardware changes are made to the device or for diagnostic readings by a technician.

Optionally, IoT device 300 includes secondary communication interface 360 which communicates with local devices over a different communication network (e.g. not by satellite). In the example of FIG. 3 the local devices are sensors and an actuator. IoT device 300 functions as a hub collecting data from a network of sensors 370.1-370.M and controlling actuator 380.

Optionally, the data collected by IoT device 300 from the sensor network is uploaded to the IoT application endpoint using satellite communication interface(s) 330. Alternately or additionally, control signals for controlling actuator(s) are downloaded to IoT device 300 over the satellite communication network using satellite communication interface(s) 330.

### II. Time Slot Selection by the IoT Device

In some embodiments described in the present disclosure, the IoT device selects time slots for transmission of data items based on a joint analysis of data type properties of the data item and respective parameter information for time slots that are available for transmission and/or reception of data items.

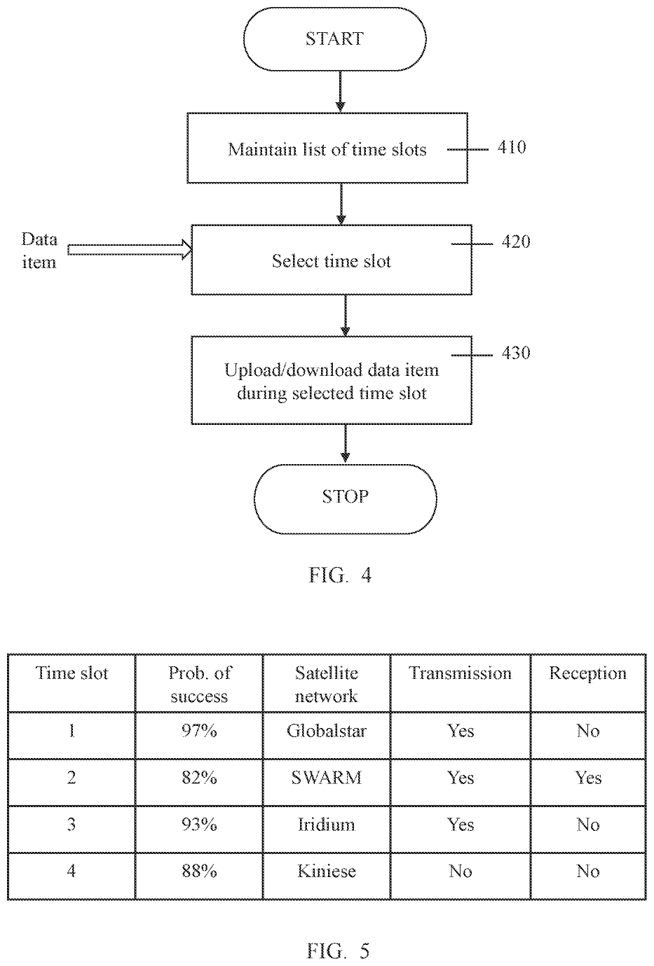

Reference is now made to FIG. 4, which is a simplified flowchart of a method of self-management of satellite communications by an Internet of Things (IoT) device, according to embodiments described in the present disclosure. The IoT has satellite communication capabilities for communicating over at least one satellite communication network.

In 410, the IoT device maintains a list of time slots which are available to the device for communicating (uploading and/or downloading) over the satellite communication network(s) which it is capable of using. The list includes respective parameter information for the available time slots.

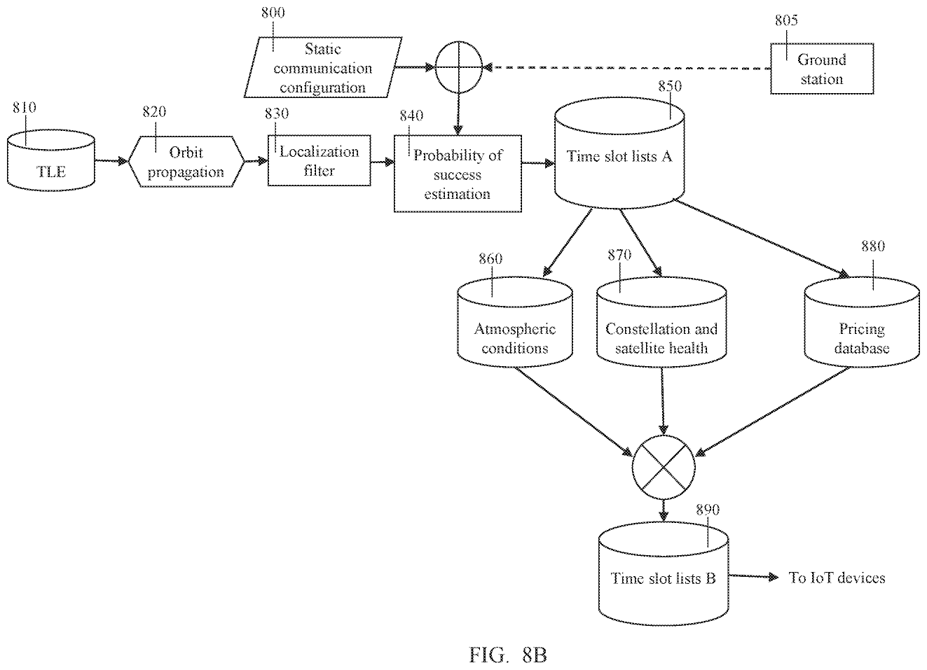

Optionally, available time slots are time periods during which respective estimated probabilities for successful communication during the time slot exceed a threshold value. Exemplary methods for determining available time slots for an IoT device at a known location are described below with reference to FIGS. 8A and 8B.

Optionally, the parameter information includes at least one of:
a) The estimated probability of success for communication during the time slot;
b) The satellite communication network associated with the time slot;
c) Whether the time slot may be used for transmission; and
d) Whether the time slot may be used for reception.

Optionally, maintaining the list includes downloading the list over the satellite communication network. In one example, the IoT device queries the facilitation for server for a list of available time slots for an upcoming time period and the server returns the list. In a second example, the IoT device receives the list of available time slots and their respective parameter information from the server over the communication network as part of a data downlink message.

In alternate embodiments, the list is pre-stored on the device before it is deployed. Over time the time slots and their parameter information may become inaccurate. Optionally, the pre-stored list is updated periodically. The update may be performed manually (e.g. by a technician) and/or by replacing the pre-stored list with an updated list received over the satellite communication network.

Referring again to FIG. 4, in 420 the device selects at least one of the available time slots for transmission of a data item. The data item type and the properties of the data item type are known. The time slot(s) are selected based on a joint analysis of properties of the data item type and respective parameter information for the time slots in the list.

Properties of a data item type may include but are not limited to:
i) Power requirements;
ii) Latency;
iii) Quality of service (QoS); and
iv) Encoding/encryption.

The time slot selection process may be made by any means known in the art. The non-limiting examples below are based on a sequential filtering process of items in the list until the optimal time slots are detected.

In a first example, the IoT device begins the time slot selection process by removing time slots which do not meet or exceed a required probability of success from the list. The IoT device then performs a filtering process in which removes time slots which do not achieve the properties required for the data item type. This selection may be done in a specified order, for example first remove time slots which require too much power, then remove time slots with acceptable QoS and so forth. If time slots are available which fulfill all the data type properties, a final selection of the time slot(s) for the data item are selected based on further rules, for example as soon as possible in time or to minimize repeats. If no time slots are available which fulfill all the data type properties the IoT device may drop the data item or place it back in the queue and attempt to find a suitable time slot at a later time.

In a further example, the IoT device performs the filtering process multiple times, in different orders of data type properties. A final selection is made from the results of the different filtering process, for example as soon as possible in time.

Optionally, not all data type properties are analyzed for every type of data item. For example, if the data item type requires low latency the nearest time slot is selected without evaluating QoS or encoding.

Optionally, the logic for selecting time slots is defined on the IoT application and is implemented by the IoT device application. For example, the IoT application may assign priorities to the data type properties which determine the order in which the IoT device filters the time slot list. For example, low latency may be a high priority for some types of data items whereas QoS may be a priority for other types of data items. When a time slot is selected for a particular data item, the selection algorithm in the IoT device application filters the results in the order defined by the IoT application. This gives the application developer control over how the data items are transmitted, without requiring knowledge of how the satellite communication is performed.

Optionally, the parameter information includes a financial cost for use of the time slot. The financial cost may be used as an additional variable for selecting time slots for a data item. For example the selection logic may attempt to reduce financial cost while still satisfying the technical requirements of power, latency etc. . . .

Multiple time slots may be selected for a single data item for several reasons. In a first example, the size of the data is too large to be transmitted during a single time slot. The data item is segmented and each segment sent during a different time slot. In a second example, the data item is transmitted multiple times when the required probability of success cannot be obtained by a single transmission the data item during a single time slot (i.e. the desired QoS cannot be achieved without retransmissions). In a third example, the data item is divided into multiple frames due to payload size and the frames are retransmitted in different time slots in order to achieve the desired QoS.

Optionally, in some cases time slot selection is not performed by the device. Instead, the IoT device sends a query over the satellite network to a destination device (e.g. the facilitation server) requesting a time slot for the type of data item to be transmitted. The queried device returns at least one time slot for transmission of the data item. The IoT device transmits the data item during the returned time slot. Alternately or additionally, selected time slots for one or more types of data items are pushed by the facilitation server to the IoT device in a periodic pre-defined manner.

In 430, the data item during is uploaded or downloaded during the selected time slot(s). When the device is capable of communicating over multiple satellite communication networks data item is uploaded over the satellite communication network associated with the time slot, as may be determined from the parameter information.

The transmission protocol may be based on the parameter information of the returned time slot and/or the data type properties. In one example, the data item is transmitted according to the required QoS for the data type. In another example, the data item is transmitted over the satellite network associated with the time slot (as indicated by the time slot list stored on the IoT device).

Optionally, before transmission the data item is stored in a queue in the device memory (e.g. first-in-first-out or last-in-first-out). Storing a data item in a queue consumes memory. Further optionally, there is a specified maximum amount of time a data item (of the given type or of any type) should be kept in memory. If a time slot is not found for the data item within this maximum time the data item is dropped from the queue.

Optionally, time slot(s) for receiving a data item of a particular type are selected similarly to the way time slots are selected for transmitting data items. The IoT device has information about what type or types of data items are expected be received. The data type properties of the expected data item and respective parameter information for the time slots is analyzed jointly to identify suitable time slots for receiving a data item of the expected type. The IoT device ensures that it is available for reception of a data item during the selected time slots. For example, in power saving mode the IoT device may turn itself off during certain time periods. The IoT device then turns itself on during time slots selected for receiving data items in order to be available to receive an expected data item.

As used herein the term “expected data item” means a data item that the IoT device prepares to receive over the satellite communication network, for example responses to queries sent by the IoT device and/or periodic updates of the list or a device code update.

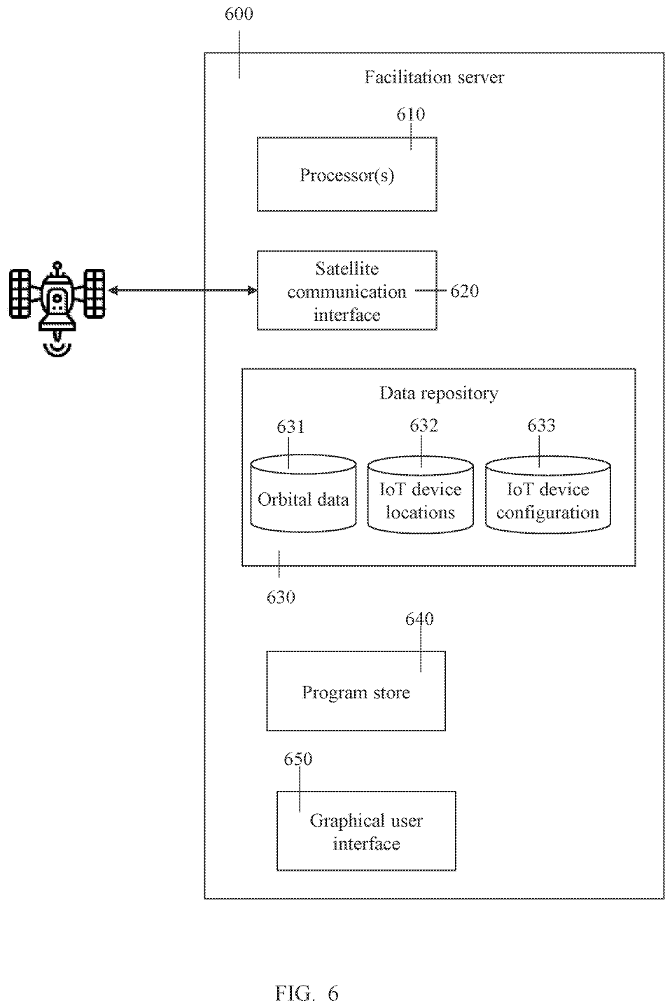

The term time slot list is non-limiting with regarding to how the items in the list are formatted and/or integrated into the processing operations performed by the device. In one example the list is stored as a table in memory, as illustrated in FIG. 5. In a second example the list is stored as a matrix, which requires certain calculations such as the L1RF_mat described below. In a third example the list is stored as a data vector.

### III) Facilitation Server

The facilitation server generates respective time slot lists for IoT devices. The available time slots for a particular IoT device are identified by the facilitation server based on factors such as the respective device locations, information about satellite communication networks, IoT device configuration and optionally additional factors.

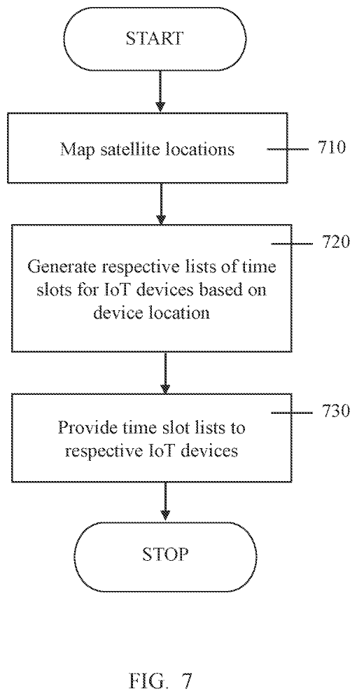

Reference is now made to FIG. 6 which is a simplified block diagram of an exemplary facilitation server, according to embodiments described in the present disclosure.

For clarity, facilitation server 600 shows a standalone computing system communicating directly over a satellite communication network. Other embodiments will be readily apparent to the skilled person (for example as a distributed system comprising multiple physical and/or virtual machines, cloud storage and so forth). In another example, the facilitation server does not include satellite communication capabilities and the data is routed to the facilitation server over a different type of network by a data broker.

Facilitation server 600 includes processor(s) 610, for example, a central processing unit(s) (CPU), a graphics processing unit(s) (GPU), field programmable gate array(s) (FPGA), digital signal processor(s) (DSP), and application specific integrated circuits (ASIC). Processor(s) 610 may include one or more processors (homogenous or heterogeneous), which may be arranged for parallel processing, as clusters and/or as one or more multi core processing units.

Facilitation server 600 includes a satellite communication interface 620 for communication with IoT devices over a satellite communication network.

Facilitation server 600 includes a data repository 630 storing data, which may include but is not limited to:
a) Orbital data 631 for multiple satellites;
b) Respective locations for the IoT devices 632; and
c) Respective configuration information for the IoT devices 633.

In one example the configuration information for an IoT device includes what modems the device has on board and which one of them is currently active. The factors determine which networks are relevant for use with the device.

In a second example, the configuration information bundles preconfigured data item types to be used for the calculation of slots. For example, if an IoT device has only one type of data item (e.g. low QoS, low power, low cost, needs to be sent approximately every 12 h) the server may supply the IoT device with a very small subset of the possible slots which are relevant to the configuration. In a second example an IoT device has two types of data items. The first data item type has very frequent downlink messages for the use of an actuator that must have a high QoS. The second data item type is a “keep alive” message with properties similar to those of the previous example. In this case the facilitation server provides all possible time slots for download (so the IoT device application knows when to wake up) but only a small subset of relevant uplink slots as in the previous example.

In other embodiments, facilitation server 600 alternately or additionally stores data in an external memory or server.

Facilitation server 600 includes a program store 640 storing code implementable by processor(s) 610, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Processor(s) 610 implement the stored code in order to perform operations required by embodiments of the invention described herein.

Optionally, facilitation server 600 includes a graphical user interface (GUI) 650. For example, the GUI may be used for one or more of: customer support, data analysis and presentation of results of the data analysis, error reports, CRM management and billing assistance.

In an exemplary embodiment the facilitation server includes a matrix calculator which calculates an L1RF_mat matrix that holds the probability of receiving a signal from a satellite of a particular network in all directions (according to an angular resolution parameter). The L1RF_mat represents the IoT devices' ability to transmit and/or receive data in a specific direction. The L1RF_mat matrix estimation uses all satellite receivers in “receive mode” while measuring satellite-originated signals' existence, RSSI, and SNR. Whenever a signal is received from a satellite, the calculator uses the satellite ephemeris and the device location to estimate the satellite's direction (both elevation and horizontal plane direction). The evaluation of the L1RF_mat is done using a Kalman filter designed to evaluate the matrix's parameters in the presence of the noise inherent to the RF communication process.

Several events may trigger the update of the L1RF_mat:
IoT device location has changed from the stored value.
An acceleration event has occurred.
A PaACK (Payload As Acknowledgment) did not finalize.

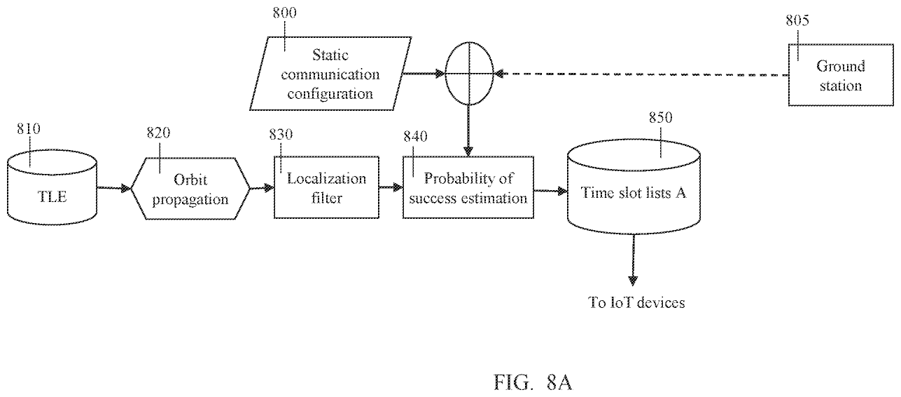

Reference is now made to FIG. 7 which is a simplified flowchart of a method of facilitating satellite communications for an Internet of Things (IoT) device according to embodiments described by the present disclosure. Optionally the method is performed by a facilitation server communicating with multiple IoT devices, for example as shown in FIG. 1.

In 710 satellite locations for a plurality of satellite communication networks are mapped. Optionally the mapping is performed by analyzing two-line element set (TLE) data for satellites in multiple satellite networks and then analyzing the orbit propagation data. In satellite communication networks the TLE may be a public domain almanac that provides information about which satellites will be visible at any given time, together with their approximate positions.

In 720 respective lists of time slots for the IoT devices are generated based on the mapping and respective physical locations of the IoT devices. The time slot list for a particular IoT device includes time slots which may be used by the IoT device for satellite communications and respective estimated probabilities of success for communication during the time slots.

In 730 the respective lists are provided to the IoT devices.

Optionally, available time slots for an IoT device are time periods during which the estimated probabilities for successful communication during the time slot exceed a threshold value. The threshold value may be the same for IoT devices or may differ from device to device. For example, the IoT application may specify respective thresholds for the IoT devices.

Optionally, the probability of success for a time slot is estimated based on at least one of:
i) Orbital information for satellites of the satellite communication network(s)—the angle and distance of the satellite influences the probability of success dramatically. TLE information is available in the public domain;
ii) Atmospheric weather conditions at the location of the IoT device—weather conditions may be modeled and used for a period of time. Data used for this modeling may be obtained from ground stations transmitting and receiving test messages for reference and/or public domain weather condition information;
ii) Transient atmospheric conditions (due to ionosphere currents, solar flares, etc.) at the location of the IoT device—These conditions may disturb space-based communications for a few hours. A sudden degradation in ground station communications may be used to recalibrate to counter these types of disruptions;
iii) Satellite constellation health—an entire satellite constellation may have technical problems. This may be determined by analyzing public domain information and/or the success rates of communications between ground stations (transmit and receive);
iv) Constellation ground gateway health—a ground station of the satellite constellation may fail even though the majority of the constellation is performing well. This may be determined by analyzing public domain information and/or success rates communications between ground stations (transmit and receive);
v) Satellite health—satellites in the same constellation may differ greatly in their performance. Measuring and calibrating for individual satellite performance improves the probability of successful communication. This may be determined by analyzing success rates of communications between ground stations (transmit and receive).

Optionally, at least one of the lists includes additional parameter information for the available time slots. Further optionally, the parameter information includes one or more of:
i) The satellite communication network associated with the time slots. Using this information, IoT devices capable of communicating over more than one satellite network may select the appropriate satellite network for transmission and/or reception of data items during a particular time slot.
ii) An indicator indicating whether uplink communication is permitted during the time slot;
iii) An indicator indicating whether downlink communication is permitted during the time slot;
iv) A financial cost for use of the time slot.

Optionally, the method further includes providing the respective list in response to a query from an IoT device.

Optionally, the method further includes pushing the respective lists to one or more IoT devices over a satellite communication network.

Optionally, the method further includes returning a selected time slot for transmission of a data item in response to a request from the IoT device. The time slot is selected from the respective time slot list for the IoT device based on the data item type and the respective estimated probabilities of success. Optionally, the selection is performed substantially similarly to the abovedescribed process for the IoT device, which is by identifying suitable time slots in the time slot list based on the data type properties followed by rule-based selection from the suitable time slots.

Reference is now made to FIGS. 8A and 8B which are simplified diagrams illustrating optional flows of operations for identifying available time slots for IoT devices according to respective embodiments described in the present disclosure. In FIG. 8A the time slot lists are based only on the estimated probability of successful communication for a device at a particular location. In FIG. 8B the initial list is narrowed based on additional factors.

Referring to FIG. 8A, static communication configuration 800 defines the desired behavior of the IoT device with regard to satellite communication. Static communication configuration 800 serves as one input to probability of success estimation 840.

In one example, the static communication configuration is in table format. The table is stored at the facilitation server. The table holds a respective static configuration (e.g. QoS parameter value) for each type of data item.

Optionally, downlink messages sent from the IoT application server to the IoT device contain data, control commands and actuator commands. The application programming interface (API) used by the IoT application server in order to send the downlink messages may have the same properties as the IoT device data items, namely: QoS, power, latency and encryption level.

For example, consider an IoT device which serves as a sensor creating data redundancy for machine learning application. Machine learning applications usually collect large amounts of data and are interested in the success or failure of a single transmission. Therefore the loss of a message is expected. This IoT device needs to transmit a single data item (e.g. message) every day and it is acceptable if the message does not always arrive. Instead the IoT device optimizes power usage so that its field life-span will be very long. A static communication configuration table file for such a device may be:

TABLE 1

| Message type | | | | Encryp- | Pre- | Estimated |
|---|---|---|---|---|---|---|
| identifier | QoS | Power | Latency | tion | scheduled? | length |
| _1 | 0 | 1 | 0 | 1(ECC) | ~24:00 | 23 Byte |

As will be apparent to the skilled person, IoT devices which send more than one type of data item will have a row for each type. Similarly, when the static configuration profile defines multiple properties for each data item type, the table will have multiple columns storing respective values for the data item properties.

As noted above, some types IoT devices only support upload. In IoT devices with no download ability (i.e. only an uplink connection), the static communication configuration may be stored on the IoT device.

Examples for storing the static communication configuration on the device include but are not limited to:
a. Flashing the data into the device memory together with the program during its initial programming;
b. Flashing the data into the device memory together with the program during maintenance.
c. Sending the data to the device using a secondary communication during maintenance (BT/BLE etc.).

When static communication configuration is stored on the IoT device, the IoT device may use this information for time slot selection.

In a first example, the IoT device performs on board calculation. This is a good fit for devices with low memory. In this case, whenever communication timing data is downloaded to the IoT device, an up-to-date copy of the device static communication configuration and relevant almanac data is downloaded to the device. However this data typically loses relevance over time.

In a second example the IoT device uses a best effort approach where it transmit messages according to a predefined policy which does not take into consideration the state of satellites in the sky or any other time varying factor, but instead retransmits with statistically reasonable timing to attempt to ensure that the message has a reasonable probability of success.

Additional information for probability of success estimation 840 is calculated from the positions of the communication satellites relative to the location of each device. TLE 810 includes almanac information for satellites in all communication networks that might be used by the IoT devices. Orbital propagation 820 calculates a series of orbit points for each satellite based on the TLE data. Localization filter 830 localizes the orbital information for the geographical location of each IoT device by identifying the segment of the orbit during which the probability of success for communication with the satellite is above a threshold value and calculating the respective time periods (i.e. time slots) during which the satellites are in the orbit segments.

Probability of success estimation 840 uses the static communication information and the time periods calculated by localization filter 830 to estimate the probability of success for communication between a particular satellite and a particular IoT device during time slots in which communication with a satellite is expected to have or exceed the required probability of success.

In one example the probability of success is calculated as follows. Stationary ground stations operate in different locations of the earth. The ground stations constantly transmit messages from the ground to satellites and receive messages from satellites to ground, thus creating data redundancy. Public domain data containing the satellites' mechanics is used to calculate the positions of satellites during the ground station's transmission attempts. The data is restructured to contain entries for: transmission characteristics, success/failure and satellite characteristics.

Machine learning (ML) is used to calculate a function that ties between the success or failure of the transmission, the communication characteristics and the available satellite angle and distance. The result is a function describing the connection between the inputs and the success of the transmission. The ML may be implemented by any algorithm known in the art, including but not limited to multi-dimensional linear regression and neural networks.

This probability function is used for 840 to calculate the available slots and to transform the available slots from the dimensions of angle and distance to the dimension of probability of success.

Optionally, the probability estimates are updated over time based on information provided by ground station 805, which analyzes received satellite signals and/or information from the public domain, for example as described above.

Time slot lists A 850 contains respective time slot lists for each IoT device based on its location. The time slot lists specify time periods and respective estimated probabilities of success for communication during the time periods. The time slot lists are sent to the respective IoT devices. Optionally time slots for which the probability of success are lower than a specified threshold are excluded from the lists.

Optionally one or more of the time slot lists include additional parameter information as described above.

FIG. 8B illustrates an embodiment in which time slot lists A 850 are processed further to account for additional factors. In the embodiment of FIG. 8B these factors are atmospheric conditions 860, constellation and satellite health 870 and pricing database 880. Atmospheric conditions 860 and constellation and satellite health 870 are degradation filters that are applied as needed to account for non-ideal conditions for satellite communications. For example, stormy atmospheric conditions at a particular location may temporarily degrade the communication link between the IoT device and a satellite while the storm persists. Poor constellation and satellite health may degrade the communication link over long periods of time or even permanently. Pricing database 880 adds a tag indicating the financial cost of transmitting and/or receiving data items during that time slot. This tag is optionally used by the IoT device for time slot selection. The pricing information may be updated when the financial costs are changed by the network operator.

After the further processing, time slot lists B 890 are output to respective IoT devices.

### IV. Application Development Tool

One benefit of the embodiments described herein is that it enables the application developer to develop the IoT application with minimal knowledge of satellite communications. At the simplest level the application developer only needs to enter data type properties. Time slot selection and reception/transmission over the satellite network is optimized automatically for these parameters.

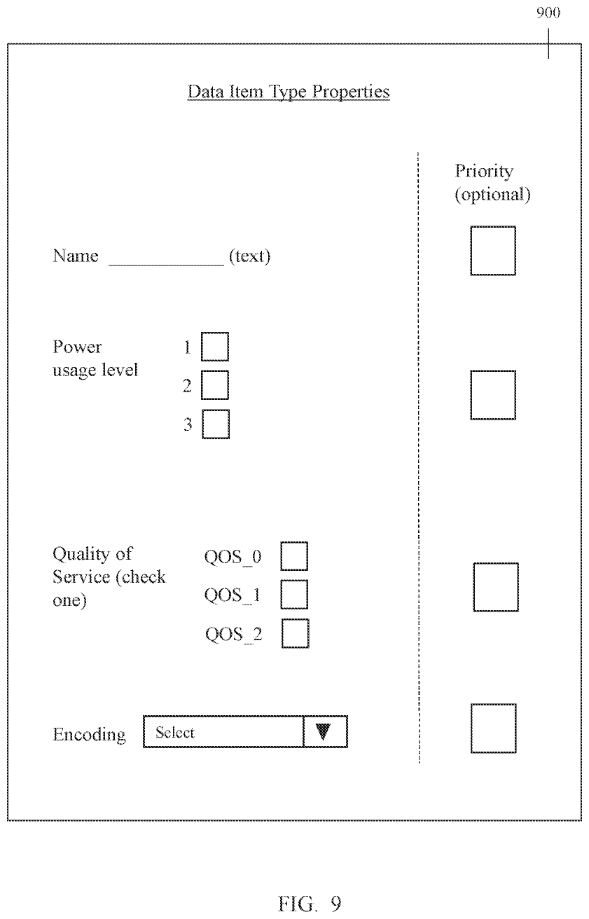

FIG. 9 shows an exemplary page 900 which is displayed on a GUI display of an IoT application development tool. Page 900 is used to input properties of a data item type. The user enters the parameter information for the fields using the GUI input device (for example by entering a numerical value or text into a data entry box, single tapping a parameter value on a touch screen, clicking a mouse on a parameter value on the screen, selecting from a dropdown box using the physical interface of the GUI).

The user enters the following information:
1) The name of the data item type (text field);
2) Power usage level (check boxes);
3) Quality of service (check boxes); and
4) Encoding (drop down menu).

Optionally the user may select the relative priority of the different types of parameters. The relative priorities may be used during the time slot selection process as described above.

Embodiments described in the present disclosure provide a simple way for optimizing satellite communications to and from IoT devices. Time slots are selected for transmission of data items based on the data item type and respective parameter information for available time slots. The time slots for transmitting data items may be selected by the device itself and/or be obtained by querying a different device over the satellite network. The time slots are selected to obtain a desired probability of success for satellite communication while minimizing usage of IoT device resources.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant IoT devices, IoT systems, IoT applications, satellite communication networks, satellite communication protocols, satellite communication interfaces, satellite modems, processors, memories and orbital information will be developed and the scope of the terms IoT device, IoT system, IoT application, satellite communication network, satellite communication protocol, satellite communication interface, modem, processor, memory and orbital information is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. An Internet of Things (IoT) device, comprising a processing circuitry configured to:
maintain a list of a plurality of time slots available to said device for communicating over at least one satellite communication network, said list comprising respective parameter information for said available time slots;
select at least one of said time slots for transmission of a data item based on a joint analysis of properties of a type of said data item and said respective parameter information; and
upload said data item during said at least one selected time slots over a satellite communication network associated with said time slot.

2. The IoT device of claim 1, wherein said respective parameter information comprises an estimated probability of success for communication during said time slot.

3. The IoT device of claim 1, wherein said device is capable of communicating over a plurality of satellite communication networks and said parameter information comprises a respective satellite network associated with said time slot.

4. The IoT device of claim 1, wherein said processing circuitry is further configured to receive data over a satellite communication network during a time slot selected based on a joint analysis of a type of said data to be received and said respective parameter information.

5. The IoT device of claim 1, wherein said time slots comprise time periods during which respective estimated probabilities for successful communication during said time slot exceed a threshold value.

6. The IoT device of claim 1, wherein for at least one of said time slots said parameter information comprises an indicator indicating at least one of whether uplink communication is permitted during said time slot and whether downlink communication is permitted during said time slot.

7. The IoT device of claim 1, wherein said properties comprise at least one of: power requirements, latency, quality of service (QoS) and encoding.

8. The IoT device of claim 1, wherein said parameter information comprise a financial cost for use of said time slot.

9. The IoT device of claim 1, wherein said maintaining said list comprises querying a server for said list of available time slots for an upcoming time period and/or receiving, from a server over a communication network, a message comprising said list of available time slots.

10. The IoT device of claim 1, wherein said selecting comprises querying a server to return at least one time slot selected from said list for transmission of said data item: wherein said IoT device functions as a hub collecting data from a network of sensors.

11. A method of self-management of satellite communications by an Internet of Things (IoT) device, comprising:
maintaining a list of a plurality of time slots available to said device for communicating over at least one satellite communication network, said list comprising respective parameter information for said available time slots;
selecting at least one of said time slots for transmission of a data item based on a joint analysis of properties of a type of said data item and said respective parameter information; and
uploading said data item during said at least one selected time slots over a satellite communication network associated with said time slot.

12. The method of claim 11, wherein said respective parameter information comprises an estimated probability of success for satellite communication during said time slot.

13. The method of claim 11, wherein said device is capable of communicating over a plurality of satellite communication networks and said parameter information comprises a satellite network associated with said time slot.

14. The method of claim 11, further comprising receiving data over a satellite communication network during a time slot selected based on a joint analysis of a type of said data to be received and said respective parameter information.

15. The method of claim 11, wherein said time slots comprise time periods during respective estimated probabilities for successful communication during said time slot exceed a threshold value.

16. The method of claim 11, wherein for at least one of said time slots said parameter information comprises an indicator indicating at least one of whether uplink communication is permitted during said time slot and whether downlink communication is permitted during said time slot.

17. A server, comprising a processing circuitry configured to:
map satellite locations for a plurality of satellite communication networks;
based on said mapping and respective physical locations of a plurality of Internet of Things (IoT) devices, generate respective lists of time slots for said IoT devices, each of said respective lists comprising a plurality of time slots available for communication by said IoT device over said satellite communication networks and respective estimated probabilities of success for said satellite communication during said available time slots; and
provide said respective lists to said IoT devices.

18. The server of claim 17, further configured to estimate said probabilities based on at least one of: orbital information for satellites of said satellite communication networks, atmospheric conditions at said location of said IoT device, satellite constellation health, satellite health and feedback from a ground station.

19. The server of claim 17, wherein said available time slots comprises time periods during which respective estimated probabilities for successful communication during said time slot exceed a threshold value.

20. The server of claim 19, wherein at least one of said lists further comprises respective parameter information for said available time slots; wherein said parameter information comprises respective satellite communication networks associated with said available time slots; wherein said parameter information comprises an indicator indicating at least one of whether uplink communication is permitted during said time slot and whether downlink communication is permitted during said time slot.
